(19) United States
(12) Patent Application Publication
(10) Pub. No.: US 2025/0226709 A1
(43) Pub. Date: Jul. 10, 2025

(54) STRUCTURE FOR AN ELECTRIC MACHINE

(71) Applicant: 1478021 B.C. Ltd., Surrey (CA)

(72) Inventors: Douglas Dane REELIE, Wichita, KS (US); Daniel Michael SABAN, Wichita, KS (US); Sreekanth NARAYANA PILLAI, Wichita, KS (US)

(21) Appl. No.: 18/849,959

(22) PCT Filed: Mar. 24, 2023
(86) PCT No.: PCT/IB2023/052954

§ 371 Date: Sep. 23, 2024

(30) Foreign Application Priority Data
Mar. 24, 2022 (GB) 2204209.7
Mar. 24, 2022 (GB) 2204210.5

(51) Int. Cl. H02K 1/278

(52) U.S. Cl. CPC H02K 1/278

(57) ABSTRACT

A laminated structure (100) for forming a rotor (1003) or a stator (1004) of an electric machine (1000), the laminated structure comprising: a plurality of laminates (200); the plurality of laminates being arranged together to provide: a circumferential support section (101); and a plurality of magnetic posts (102) connected to the circumferential support section; wherein at least one of the magnetic posts comprises a plurality of support connections (106) connecting the magnetic post to the circumferential support section; at least two of the plurality of support connections being formed in different laminates of the laminated structure to one another and connecting one of the plurality of magnetic posts to the circumferential support section at different circumferential positions on the post and/or the circumferential support section.

### TECHNICAL FIELD

The present disclosure relates to a structure for an electric machine. More specifically the disclosure relates to structures which provide reduced magnetic flux leakage.

### BACKGROUND

Electric machines typically comprise a stator defining a cylindrical bore therein and a rotor which rotates with respect to the stator, about an axially extending axis within the bore. The stator is generally configured to receive a plurality of windings connected to an electrical supply which delivers an electric current to the windings. The rotor is generally configured to contain a plurality of magnets, creating a magnetic coupling between the two components. An air gap is formed between the rotor and the stator when the stator and the rotor are in an operational position.

By modifying the electric current entering the stator, the magnetic field between the rotor and the stator changes. This change in magnetic field causes the rotor to rotate, creating a physical output from an electrical input. In this arrangement, the electric machine operates as a motor. Alternatively, by physically rotating the rotor, the magnetic field fluctuates, which induces an electric current in the stator. Therefore, a physical input can be used to generate an electrical output. In this arrangement, the electric machine operates as a generator.

Stators and rotors can be formed by fixing together a plurality of laminated layers. Laminated construction is often used in stators to reduce eddy currents. It can also be used in rotors to create parts from thin sheets of metal, which has the benefit of allowing punch press forming.

Each layer may be stamped from a thin sheet of magnetically conducting material and then glued or otherwise attached to other layers. The combined layers may form a substantially cylindrical body or core of the rotor or stator. In a permanent magnet machine, holes within each of the layers can be aligned to form slots, such that magnets can be inserted into the core body.

When designing rotors or stators, the core is required to be sufficiently stiff, in order to ensure that the rotor is able to withstand the torque and moments to which it is subjected during operation and that the stator can sufficiently react those forces. This is often achieved by increasing the volume of material to increase its mechanical properties, which also has drawbacks.

The present invention seeks to provide an improved rotor which overcomes or mitigates one or more problems associated with the prior art.

### SUMMARY OF THE INVENTION

According to an aspect of the invention, there is provided a laminated structure for forming a rotor or a stator of an electric machine, the laminated structure comprising: a plurality of laminates; the plurality of laminates being arranged together to provide: a circumferential support section; and a plurality of magnetic posts connected to the circumferential support section; wherein at least one of the magnetic posts comprises a plurality of support connections connecting the magnetic post to the circumferential support section; at least two of the plurality of support connections being formed in different laminates of the laminated structure to one another and connecting one of the plurality of magnetic posts to the circumferential support section at different circumferential positions on the post and/or the circumferential support section.

The at least two of the plurality of support connections may be formed in different adjoining laminates of the laminated structure to one another.

This presents the advantage of introducing voids or discontinuities to the axial profile of the laminated structure. The volume of the magnetic material forming the laminated structure may be reduced with this feature, as the support connections are generally axially staggered. This can improve magnetic flux restriction without excessively reducing mechanical strength.

The plurality of laminates may further comprise: a first plurality of laminates comprising a first plurality of support connections; and a second plurality of laminates comprising a second plurality of support connections; wherein the first plurality of support connections are formed at different circumferential positions on the post and/or the circumferential support section to the second plurality of support sections.

The second plurality of laminates may have a different rotational orientation relative to the first plurality of laminates, which difference causes the first plurality of support connections to be formed at different circumferential positions on the post and/or the circumferential support section to the second plurality of support sections.

With this configuration, the laminated structure according to the first aspect of the invention may be achieved without significantly increasing the steps of manufacture.

At least one of the first plurality of laminates may be arranged contiguously with at least one of the second plurality of laminates within the at least one laminated structure. Each of the first plurality of laminates may be arranged contiguously with at least one of the second plurality of laminates within the at least one laminated structure.

By alternating the first plurality of laminates with the second plurality of laminates, the support connections of a given post may comprise support connections formed at different circumferential positions on the post and/or the circumferential support section. This provides a structure with increased stiffness, as magnetic posts are formed co-axially. In this way, the laminates provide structural integrity through the axial direction with a reduced volume.

The first plurality of laminates and the second plurality of laminates may be substantially geometrically identical.

This provides an arrangement with simplified manufacturability, as both pluralities of the laminates can generally be mass-produced in an automated process. In turn, mass production may yield greater precision and reduced costs as a result of automation.

The at least one flux restriction aperture may pass partially through the at least one post in a direction of the rotational axis. The at least one flux-restriction aperture may pass completely through the at least one post in a direction of the rotational axis.

The at least two of the plurality of support connections which are formed in different laminates of the structure to one another, and which connect one of the plurality of magnetic posts to the circumferential support section at different circumferential positions on the post and/or the circumferential support section, may overlap one another.

The laminated structure may comprise a rotational array of the magnetic posts, a plurality of the magnetic posts of the array each comprising a plurality of respective support connections connecting the respective magnetic post to the circumferential support section; at least one set of the respective support connections being formed in different laminates of the laminated structure to one another and connecting a respective one of the plurality of magnetic posts to the circumferential support section at different circumferential positions on the post and/or the circumferential support section.

The first plurality of laminates and the second plurality of laminates may be arranged alternately within the at least one laminated structure.

An aspect of the invention can provide an electric machine, comprising: a stator; a rotational axis; and a rotor; the rotor being rotatably mounted, to rotate relative to the stator about the rotational axis. The rotor or the stator may comprise a structure, such as a magnetically permeable core, which may be for holding magnets or magnetisable elements. According to an aspect of the invention, the structure comprises: a circumferential support section; a plurality of magnetic posts connected to the circumferential support section; wherein at least one of the magnetic posts comprises: a plurality of support connections connecting the at least one magnetic post to the circumferential support section; wherein at least two of the plurality of support connections bound at least one flux restriction aperture defined in the at least one magnetic post.

At least one of the magnetic posts may comprise a magnetically conducting region comprised primarily of magnetically conductive material. Where the region comprises primarily or is comprised primarily of a magnetically conductive material, the region is primarily, for example in the majority, comprised of magnetically conductive material, such that the region may conduct magnetic flux more favourably than a flux restricting region even if minor voids or non-magnetically conductive regions are present. At least one of the magnetic posts may comprise a flux restricting region comprising the support connections and the at least one flux restriction aperture. At least one of the magnetic posts may have a post height (H1), measured from the base of the at least one post, adjacent the circumferential support section, to a tip of the at least one post, distal from the circumferential support section. The flux restricting region may comprise a restricting region height (H2). The flux restricting region height (H2) generally defines the length of the support connection bounding the flux-restricting region.

The flux restricting region height (H2) may extend over at least one fifth of the post height (H1). The restricting region height (H2) may extend over at least one quarter of the post height (H1). The restricting region height (H2) may extend over at least one third of the post height (H1). Such configurations provide advantageous mechanical properties while still sufficiently restricting flux.

The flux restricting region height (H2) may extend over at least one half of the post height (H1). The restricting region height (H2) may extend over at least three fifths of the post height (H1). With these configurations, the flux restriction performance of the support connections may significantly be enhanced. The mechanical properties of the structure with can be improved by the assembly methods disclosed later herein.

The distance between opposed inner circumferences of the circumferential support section may define a first diameter (D1). This may otherwise be defined as being twice the length of a first radius measured from the rotational axis L to the inner circumference.

The distance between opposed outer circumferences of the circumferential support section may define a second diameter (D2). This may otherwise be defined as being twice the length of a second radius measured from the rotational axis L to the outer circumference.

The distance between the distal ends of any two opposed support connections may define a third diameter (D3). This may otherwise be defined as being twice the length of a third radius measured from the rotational axis L to the distal end of any one of the support connections.

The distance between the distal ends of any two opposed magnetic posts may define a fourth diameter (D4). This may otherwise be defined as being twice the length of a fourth radius measured from the rotational axis L to the distal end of any one of the magnetic posts.

The third diameter (D3) may be equal to or greater than 1.1 times the second diameter (D2). The third diameter (D3) may be equal to or greater than 1.2 times the second diameter (D2). The third diameter (D3) may be equal to or greater than 1.3 times the second diameter (D2).

A length to width aspect ratio of the one or more support connections may be 3:1 or more; or 5:1 or more; or 9:1 or more; or 20:1 or more; or 30:1 or more.

At least two adjacent posts of the plurality of posts may each comprise a first side wall defining a first lateral extent of a post crown and a second side wall defining a second lateral extent of a post crown. At least one magnet-retaining slot may be defined between a first side wall of one of the at least two adjacent posts and a second side wall of the other of the at least two adjacent posts.

Each of the plurality of posts may comprise a first side wall defining a first lateral extent of a post crown and a second side wall defining a second lateral extent of a post crown. Magnet-retaining slots may be defined between each first side wall of the posts and each second side wall of the adjacent post.

The post height (H1) may be measured in a direction parallel to the first or second side walls of the post crowns. The flux restriction region height (H2) may be measured in a direction parallel to the first or second side walls of the post crowns.

According to a further aspect of the invention there is provided a laminate for forming a laminated rotor or stator of an electrical machine, the laminate comprising: a circumferential support member; and a plurality of magnetic post members, each magnetic post member being circumferentially centred about a respective radius of the laminate; each magnetic post member comprising at least one support connection extending from the circumferential support member to a respective magnetic post member and connecting to the magnetic post member and/or the circumferential support member at a point away from the respective radius about which the respective magnetic post member is centred.

At least one magnetic post member and the support connection(s) connecting the at least one magnetic post member to the circumferential support member may define an asymmetric cross-sectional profile.

Each or a plurality of the magnetic post members of the laminate may be substantially geometrically identical. That is, the magnetic post members may comprise the same properties of any one or more of length, cross-sectional area, volume, and perimeter. A plurality or each of the magnetic post members comprise the same properties for any or all of these properties.

The plurality of magnetic post members may comprise: a first plurality of magnetic post members comprising a first plurality of support connections extending from the circumferential support member connecting the magnetic post members to the circumferential support member; and a second plurality of magnetic post members comprising a second plurality of support connections extending from the circumferential support member connecting the magnetic post members to the circumferential support member.

The cross-sectional profiles of the second plurality of magnetic post members may comprise mirror symmetry with the cross-sectional profiles of the first plurality of magnetic post members.

The laminate may further comprise an alignment feature. The alignment feature may comprise a protrusion or a recess on an inner or outer circumference of the laminate.

During manufacture, this may provide a mistake-proofing feature which ensures that the correct alignment of the laminates is maintained when they are being stacked. It may otherwise function as a means which can be detected digitally for an automation system to use as a reference point.

According to a further aspect of the invention, there is provided a laminate for forming a laminated rotor or stator of an electrical machine, the laminate comprising:
a circumferential support member; and
at least one magnetic post member comprising at least one support connection connecting the at least one magnetic post member to the circumferential support member;
wherein the laminate is configured such that, when a plurality of such laminates is arranged co-axially, co-axial magnetic post members form at least one magnetic post comprising:
a plurality of support connections connecting the at least one magnetic post to the circumferential support section;
wherein at least two of the plurality of support connections bound at least one flux restriction aperture defined in the at least one magnetic post.

The at least one magnetic post member may comprise a magnetically conducting region comprised primarily of magnetically conductive material; and a flux restricting region comprising the at least one support connection; the at least one magnetic post member having a post height (H1), measured from the base of the at least one post, adjacent the circumferential support section, to a tip of the at least one post member, distal from the circumferential support section; wherein the flux restricting region has a flux restricting region height (H2) which extends over at least one fifth of the post height.

The flux restricting region height (H2) of the magnetic post member may extend over at least one quarter of the post height (H1). The flux restricting region height (H2) of the magnetic post member may extend over at least one third of the post height (H1).

It will be therefore understood by the person skilled in the art that, for any aspect relating to a laminate for forming any laminated structure according to the present invention, the laminate itself may comprise any property or characteristic that is disclosed herein with reference to any laminated structure.

According to a further aspect of the invention there is provided a method for providing a stator or a rotor for an electric machine, comprising providing a plurality of laminates, at least one of the laminates comprising: a circumferential support member; and a plurality of magnetic post members, comprising a plurality of support connections extending circumferentially from the circumferential support member and connecting the magnetic post members to the circumferential support member; the method comprising forming a laminated structure by arranging the plurality of laminates together, the laminated structure comprising: a circumferential support section; and at least one magnetic post formed from at least two of the magnetic post members; wherein the step of forming the laminated structure comprises providing at least two of the plurality of support connections in different laminates of the laminated structure to one another, the at least two of the plurality of support connections connecting at least one of the plurality of magnetic posts to the circumferential support section at different circumferential positions on the post and/or the circumferential support section.

At least two laminates of the plurality of laminates may each comprise: at least one magnetic post member; and at least one support connection connecting the at least one magnetic post member to the circumferential support member; wherein at least one magnetic post member of each laminate defines an asymmetric cross-sectional profile, the method further comprising the step of arranging the at least two laminates together, such that respective magnetic post members which each define asymmetric cross-sectional profiles together form at least one post comprising a symmetrical cross-sectional profile.

The method may further comprise arranging at least two of the plurality of support connections of one of the plurality of magnetic posts in different contiguous laminates of the structure to one another such that the magnetic post is connected to the circumferential support section at different circumferential positions on the post and/or the circumferential support section.

The plurality of laminates provided may further comprise: a first plurality of laminates comprising a first plurality of support connections; and a second plurality of laminates comprising a second plurality of support connections; the method further comprising forming the laminated structure such that the first plurality of support connections are formed at different circumferential positions on the post and/or the circumferential support section to the second plurality of support sections.

The method may further comprise the step of rotating the second plurality of laminates relative to the first plurality of laminates such that the first plurality of support connections are formed at different circumferential positions on the post and/or the circumferential support section to the second plurality of support sections.

At least two of the plurality of laminates may each comprise an alignment feature indicating the correct orientation of the at least two laminates.

The method may further comprise arranging at least one of the first plurality of laminates contiguously with at least one of the second plurality of laminates within the at least one laminated structure.

The method may further comprise arranging the plurality of laminates together such that the at least two of the plurality of support connections of at least one post bound at least one flux-restriction aperture defined in the at least one post.

The method may further comprise arranging the plurality of laminates together such that the plurality of support connections of at least one post bound at least one flux-restriction aperture defined through the at least one post.

A further aspect of the invention provides an electric machine comprising: a stator; a rotor having a rotational axis; the rotor being rotatably mounted for rotation relative to the stator about the rotational axis. At least one of the stator and the rotor may comprise: a laminated structure of any aspect described herein; or a laminate according to any aspect described herein; or a laminated structure formed according to any method described herein.

Within the scope of this disclosure, it will be apparent, and is expressly intended that the various aspects, embodiments, examples and alternatives set out in the disclosure, in the claims and/or in the following description and drawings, and in particular the individual features thereof, may be taken independently or combined in any combination. That is, all embodiments and/or features of any embodiment can be combined in any suitable way.

### BRIEF DESCRIPTION OF THE DRAWINGS

Further features and advantages of the present invention will be further described below, by way of example only, with reference to the accompanying drawings in which:

FIG. 1 shows a schematic cross-sectional view of an embodiment of a rotor body according to a first aspect;

FIG. 2 shows a schematic enlarged perspective view of the rotor body of FIG. 1;

FIG. 3 shows a schematic enlarged cross-sectional view of the rotor body of FIG. 1 when arranged with magnets, depicting the directions of magnetic flux;

FIG. 4 shows a schematic cross-sectional view of an embodiment of a laminate according to a second aspect, for use in assembling the rotor body of FIG. 1;

FIG. 5 shows a schematic enlarged perspective view of an embodiment of a first alternative rotor body according to the first aspect;

FIG. 6 shows a schematic cross-sectional view of an embodiment of a first alternative laminate according to a second aspect, for use in assembling the rotor body of FIG. 5;

FIG. 7 shows a schematic enlarged perspective view of an embodiment of a second alternative rotor body according to the first aspect;

FIG. 8 shows a schematic enlarged cross-sectional view of an embodiment of a second alternative laminate according to the second aspect, for use in assembling the rotor body of FIG. 7;

FIG. 9 shows a schematic cross-sectional view of an embodiment of a third alternative rotor body according to the first aspect;

FIG. 10 shows a schematic enlarged perspective view of the alternative rotor body of FIG. 9;

FIG. 11 shows a schematic cross-sectional view of an embodiment of a third alternative laminate according to a second aspect, for use in assembling the alternative rotor body of FIG. 9;

FIG. 12 shows a schematic enlarged cross-sectional view of the alternative rotor body of FIG. 9 when arranged with magnets, depicting the directions of magnetic flux;

FIG. 13 shows a flow diagram of an embodiment of a method according to a third aspect; and

FIG. 14 shows a schematic diagram of an embodiment of an electric machine according to a fourth aspect.

### DETAILED DESCRIPTION

The present disclosure provides improvements in the construction of magnetic and structural aspects of a rotor or stator in an electric machine. In some examples, such as magnetic amplification rotors, the slots within the rotor body may be arranged to hold magnets such that poles with the same polarity are facing towards one another, typically with a magnetically conductive post in between each pair of magnets. In this way, the magnetically conductive material between each slot acts to amplify magnetic flux and direct it toward the stator.

Adding material to a rotor or stator in order to improve the mechanical properties can also amplify the phenomenon of magnetic flux leakage. This introduces inefficiencies in the system, which can reduce the available torque and thus worsen performance. In high pole-count motors, in particular, the amount of material holding the magnets in place is generally less than that of similarly sized low pole-count motors. The following examples seek to provide improved magnetic and mechanical structures, to balance the benefits of providing reduced flux leakage while providing sufficient mechanical strength. While certain embodiments described herein relate to laminated structures, the cross-sectional forms and dimensions described may be equally applied to non-laminated structures.

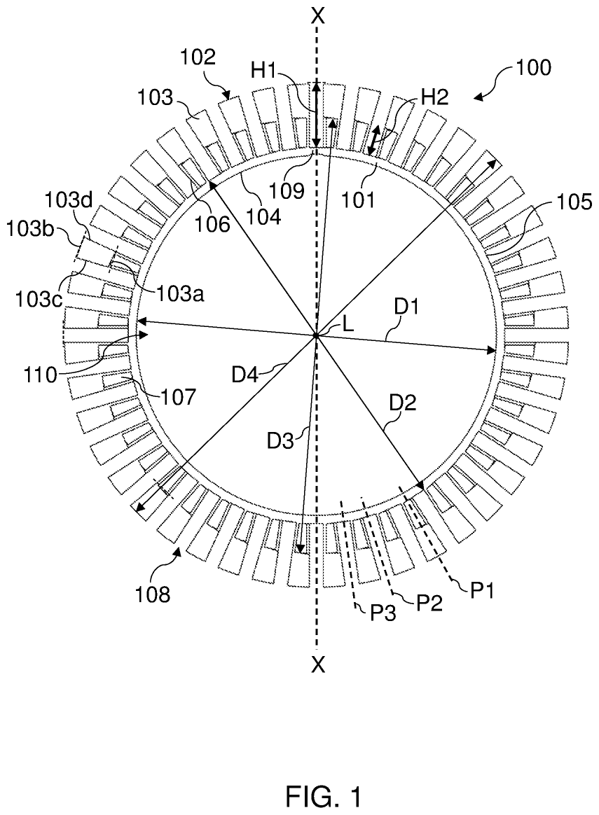

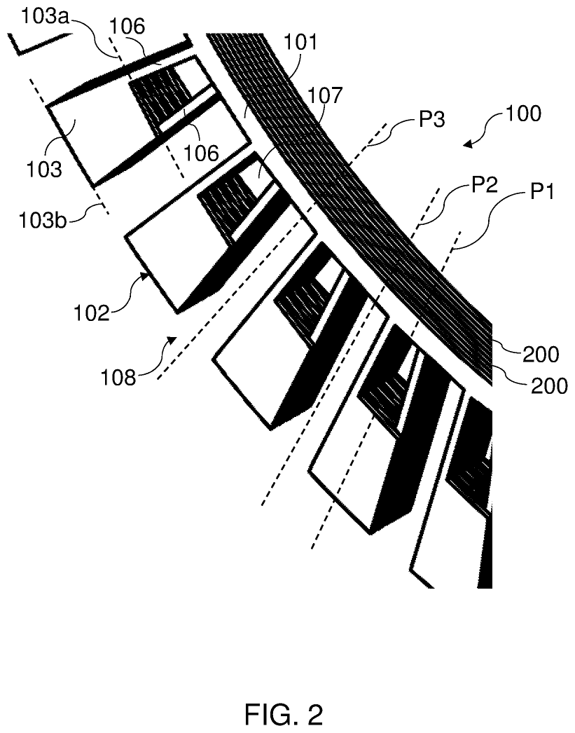

Referring firstly to FIGS. 1 and 2, there is shown a laminated structure 100 according to a first example. The laminated structure 100 is generally formed from a plurality of laminated discs 200, or laminates, arranged in a stacked configuration. The discs may be stamped or punched from a thin sheet of magnetically conductive material, such as steel. In the example of FIG. 1 the laminated structure 100 comprises a rotor body. It will be understood that in alternative examples, the laminated structure may otherwise comprise a stator assembly.

The laminates of the rotor body 100 may be formed of magnetically permeable material. For example, the laminates of the rotor body 100 may be formed from an iron alloy or other material comprising an iron alloy. It is important that the material used to produce the laminated discs is of a high stiffness, so as to resist deformation by the torque generated by the motor during operation.

The rotor body 100 comprises a circumferential support section 101. Generally, the circumferential support section 101 may be annular and comprises an inner circumference 104 and an outer circumference 105. Within the inner circumference 104 of the circumferential support section 101, there may be defined a bore 110 of generally circular cross-section. The circumferential support section 101, being integral to the laminates of the rotor body, may be formed of magnetically conductive material and can form part of a magnetic circuit defined by the rotor body 100 and the associated magnetic elements located in the slots 108. The circumferential support section 101 can provide a leakage path for the magnetic flux between adjacent poles within the rotor body 100. It is desirable to avoid flux leakage to the back iron and it is beneficial for flux to be directed to the airgap between the rotor and stator of an electric machine. In the example of FIG. 1, the circumferential support section 101 comprises a back iron. The circumferential support section 101 may otherwise comprise a front iron. Alternatives may be envisaged in examples where the laminated structure may be comprised in a stator assembly, for example, or in an out-runner rotor arrangement where the inner stator may be stationary, and the outer rotor rotates.

The rotor body 100 is generally configured to be rotatably mounted within a bore of a stator assembly (not shown); the rotor body 100 may be configured to rotate about a rotational axis L which extends axially through the inner circumference 104 of the back iron 101. To perform this function, the inner circumference 104 of the rotor body 100 may be mounted to a drive shaft (not shown) or bearing arrangement (not shown).

The rotor body 100 further comprises a plurality of posts 102 connected to the back iron 101. Posts may otherwise be referred to as teeth. The plurality of posts 102, also being integral to the laminates of the rotor body, may be formed of magnetic material and extend radially outwards from the back iron 101. It will be appreciated that, in examples comprising a front iron that the posts may extend radially inwards from the front iron. Generally, the posts 102 of the rotor body 100 are arranged with equal spacing along the circumference of the circumferential support section 101.

The posts 102 are arranged to enable magnetic flux to flow through the rotor body 100. Each of the plurality of posts 102 comprises a magnetically conductive crown 103. Each post crown 103 comprises a first, proximal end 103a which may be connected to the back iron and a second, distal end 103b. Each post crown 103 further comprises a first side wall 103c defining a first lateral extent of the post crown 103 and a second side wall 103d defining a second lateral extent of the post crown 103.

Each post 102 comprises a plurality of support connections 106 by which the posts are connected to the back iron 101. The plurality of support connections 106 extend radially from the outer circumference 105 of the back iron 101 to the proximal ends 103a of the crowns 103 of the posts 102. In the example of FIG. 1, each post 102 may be connected to the back iron 101 by two support connections 106. It will be understood by the person skilled in the art that each post 102 may otherwise be connected to the back iron by three or more support connections 106. The support connections 106 of a single post 102 may bound a flux restriction aperture 107 defined in the associated post 102.

The rotor body 100 generally comprises a plurality of magnet-retaining slots 108 which are each configured to receive a permanent magnet or another magnetic element such as a magnetic winding if appropriate. The magnet-retaining slots 108 may generally be bounded between adjacent posts 102 by the support connections 106 and the side walls 103c, 103d of the adjacent post crowns 103.

The rotor body 100 comprises a first diameter D1 which is the distance between opposed inner circumferences 104 of the circumferential support section 101. This may otherwise be defined as being twice the length of a first radius measured from the rotational axis L to the inner circumference 104. The first diameter D1 relates to the diameter of the bore defined within the rotor body.

The rotor body 100 comprises a second diameter D2 which is the diameter between opposed outer circumferences 105 of the circumferential support section 101. This may otherwise be defined as being twice the length of a second radius measured from the rotational axis L to the outer circumference 105. The second diameter D2 relates to the radial extent of the back-iron 101. The difference between the second diameter D2 and the first diameter D1 generally indicates the radial thickness of the back-iron 101.

In certain arrangements, D1 may be maximised as this can increase the volume available to house components, shafts, or other ancillary features within the bore 110 of the body 100. With this configuration, the rotor body 100 may help to address packaging constraints within the associated electric machine. Additionally, a larger inner diameter of the back iron corresponds to a lower mass.

Optionally, some configurations may minimise the difference between D2 and D1 as this corresponds to a thin back iron. A back iron of reduced volume can be less prone to magnetic flux leakage and may yield an improved power to weight ratio. This can contribute to maximising torque outputs for a machine of a given weight. Thus, the second diameter D2 may be equal to or less than 1.5 times greater than the first diameter D1. The second diameter D2 may be equal to or less than 1.3 times greater than the first diameter D1. In alternative arrangements, the second diameter D2 may be equal to or less than 1.1 times greater than the first diameter D1. The second diameter may be equal to or less than 1.05 times greater than the first diameter D1. In other configurations, the difference between D2 and D1 may be increased. A radially thicker back iron may provide increased structural rigidity.

The rotor body 100 comprises a third diameter D3 which is the diameter between the distal ends of any two opposed support connections 106. This may otherwise be defined as being twice the length of a third radius measured from the rotational axis L to the distal end of any one of the support connections 106.

The third diameter D3 is indicative of the radial extent of a flux restricting region, described in more detail later on. An increased third diameter D3 generally corresponds to flux-restricting regions of increased area, which in turn enhances the flux restriction of the overall structure.

For configurations to optimise the rigidity of the overall structure, the third diameter D3 may be equal to or greater than 1.1 times greater than the first diameter D2. Otherwise, the third diameter D3 may be equal to or greater than 1.2 times greater than the second diameter D2. In some configurations, the third diameter D3 may be equal to or greater than 1.25 times second diameter D2. This provides a design in which the restricting region has a greater radial extent, and thus a greater area.

For configurations to optimise the flux restriction of the laminated structure, the third diameter D3 may be equal to or greater than 1.3 times second diameter D2. Optionally, the third diameter D3 may be equal to or greater than 1.4 times the second diameter D2. In the present invention, the length of the support connections 106 can be increased as they maintain sufficient stiffness through the manufacturing methods described in the subsequent description. Thus, in some embodiments the third diameter D3 may be equal to or greater than 1.5 times the second diameter D2.

The relationship between the second diameter D2 and the third diameter D3 may be independent of the relationship between the first diameter D1 and the second diameter D2. Despite this, various combinations of properties can be achieved by combining the relationships. For example, a lower ratio of D2 to D1 corresponds to a thinner back iron. In conjunction with an increased ratio of D3 to D2, the structure may provide a lightweight back iron with improved flux restriction properties.

The rotor body comprises a fourth diameter D4 which is defined as the distance between the distal ends of any two opposed magnetic posts. This may otherwise be defined as being twice the length of a fourth radius measured from the rotational axis L to the distal end of any one of the magnetic posts 103.

To increase rigidity of the structure, minimising the ratio of D4 to D1 may be beneficial. This can also provide a lower mass machine comprising less material. The fourth diameter D4 may be equal to or less than 1.6 times the first diameter D1. Optionally, the fourth diameter D4 may be equal to or less than 1.5 times the first diameter D1. In particularly rigid embodiments, the fourth diameter D4 may be equal to or less than 1.4 times the first diameter D1. This dimension limits the radial extent of the post crowns and thus, a smaller fourth diameter D4 can provide a lower mass or smaller sized rotor.

The at least one of the magnetic posts 102 may have a post height H1, measured from the base of the at least one post 102, adjacent the circumferential support section 101, to a to a tip of the at least one post, distal from the circumferential support section. The extent of H1 can also be taken to be the distal end 103b (FIG. 2) of the post crown 103.

The flux restricting region may comprise a restricting region height H2. The flux restricting region height H2 generally defines the length of the support connection bounding the flux-restricting region. The restricting region height H2 is measured from the base of the at least one post 102, adjacent the circumferential support section 101, to a proximal end 103a of the post crown 103.

For embodiments where H1 and H2 extend in a radial direction from the outer circumference of the circumferential support section:

$$H 1 = \frac{1}{2} ( D 4 - D 2 )$$

$$H 2 = \frac{1}{2} ( D 3 - D 2 )$$

$$H 2 = H 1 - \frac{1}{2} ( D 4 - D 3 )$$

Half of the difference between the fourth diameter D4 and the third diameter D3 generally corresponds to the radial extent of each magnetically conductive post crown 103. Increasing this difference thus corresponds to an increase of the radial extent of the post crown 103, and in turn the depth of magnetic material in the post 102. It will be appreciated that increasing the fourth diameter D4 for a given third diameter D3 decreases the ratio of H2 to H1.

For configurations to optimise the depth of magnetic material, it is required to increase H1 relative to H2, thereby decreasing the ratio of H2 to H1. For these configurations, the flux restricting region height H2 may extend over at least one fifth of the post height H1. The restricting region height H2 may extend over at least one quarter of the post height H1. The restricting region height H2 may extend over at least one third of the post height H1. The restricting region height H2 may extend over at least one half of the post height H1. Such configurations provide advantageous flux restriction and can provide suitable mechanical properties.

Otherwise, for configurations to optimise the performance of flux restriction, increasing H2 relative to H1 can be beneficial. In such configurations, the flux restricting region height H2 may extend over at least one half of the post height H1. The restricting region height H2 may extend over at least three fifths of the post height H1. With these configurations, the flux restriction performance of the support connections may be significantly enhanced. The mechanical properties of the structure with can be improved by the assembly methods disclosed later herein.

In the example of FIGS. 1 and 2, for each post 102, the plurality of support connections 106 are formed in different laminates of the rotor body 100 to one another. For each post 102, the associated plurality of support connections 106 also connects the post 102 to the back iron 101 at two different circumferential positions on the post 102.

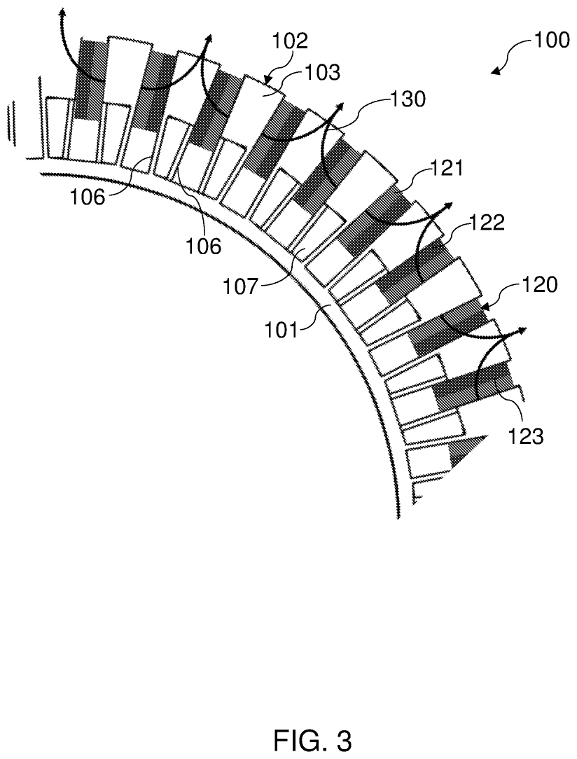

As shown in FIG. 3, magnets 120 may be disposed within each of the slots 108. The magnets 120 each comprise a north pole 121 and a south pole 122. The poles 121, 122 define a north-south plane 123 extending longitudinally therebetween. Specifically, the north-south plane 123 defines a plane dividing the north pole 121 from the south pole 122. The magnets 120 may be circumferentially polarised. In this configuration, the north pole 121 of each magnet is arranged facing towards the north pole 121 of an adjacent magnet and the south pole 122 of each magnet is arranged facing towards the south pole 122 of an adjacent magnet.

As already noted, each post comprises a post height H1 which is measured from a base of the post located at the outer circumference 105 of the back iron 101 to a distal end 103b of the crown 103. The post height H1 may be measured in a direction parallel to the north-south plane of the at least one magnet. Similarly, the flux restriction region height (H2) may be measured in a direction parallel to the first or second side walls of the post crowns.

In use, each crown 103 defines a magnetically conducting region of the associated post 102. Due to like poles being adjacent to one another, magnetic flux 130 at a pole of one magnet is forced towards an outer circumference of the rotor body 100 by the posts 102 which amplify the magnetic flux from the magnets. This directs flux towards the air gap and thus the stator (not shown) of the electrical machine. By amplifying the magnetic flux of the magnets and minimising magnetic flux leakage elsewhere in the rotor body 100, the torque of the associated electric machine can be maximised.

Magnetic flux leakage may be caused by the air gap, as the air therein comprises non-magnetic material and therefore possesses an increased reluctance compared to the rotor body or the stator assembly. Minimising the length of the air gap reduces leakage as the magnetic linkage between the rotor body and the stator assembly is increased. Magnetic flux leakage may also be caused by magnetic flux which is not directed towards the stator. Leaked flux tends to return to the opposing pole of the associated magnet rather than being directed across the air gap.

To reduce magnetic flux leakage via the back iron between adjacent posts 102, the support connections 106 of a single post 102 may bound at least one flux restriction aperture 107 defined in the post 102. The flux restriction apertures 107 may be further bounded by the outer circumference 105 of the back iron 101. The flux restriction apertures 107 reduce flux leakage by introducing an increased reluctance to the linkage of magnetic flux through the associated posts 102. With this arrangement, magnetic flux which would otherwise have been directed toward the back iron between neighbouring posts 102 instead favours being directed across the air gap between the rotor body 100 and the stator assembly.

Thus, each post 102 may comprise a flux restricting region comprising the support connections 106 and the associated flux restriction aperture 107. The flux restricting region may extend over at least one fifth of the post height H1. The flux restricting region may extend over at least one quarter of the post height H1. The flux restricting region may otherwise extends over at least one third of the post height H1. Increasing the proportion of the post 102 along which the flux restricting region extends in turn increases the cross-sectional area of the flux restriction aperture 107.

To maximise the effectiveness of flux restriction, it can be optimal to increase the cross-sectional area of the flux restricting region relative to the cross-sectional area of the support connections bounding the flux restricting region. In a high pole count electric machine, maximising the area of the flux restricting region is constrained circumferentially by the need to provide several posts.

In conventional arrangements, reducing the area of the support connections—for example, by forming them to be thinner—is usually at the expense of the stiffness of the posts. In use, as the rotor body may be subject to high torque, the rotor posts may be subject to bending moments. It is therefore not viable to reduce the area of the support connections in a conventional electric machine, as thinner, longer support connections are more susceptible to mechanical failure. The present invention presents a solution which makes such configurations more achievable.

Each support connection 106 comprises a length extending from the circumferential support section, and a width extending laterally relative to the length. The ratio of the length of a support connection 106 relative to the width of said support connection 106 can be defined as the aspect ratio.

In some configurations, one or more of the support connections may comprise a length which is equal to or greater than 3 times the width of the support connection. This corresponds to an aspect ratio of 3:1 or greater. Optionally, one or more of the support connections may comprise a length which is equal to or greater than 5 times the width of the support connection. This corresponds to an aspect ratio of 5:1 or greater. One or more of the support connections may comprise a length which is equal to or greater than 9 times the width of the one or more support connections. Thus, the support connections may comprise aspects ratios of 9:1 or greater.

In some configurations, one or more of the support connections may comprise a length which is equal to or greater than 20 times the width of the support connection. This corresponds to an aspect ratio of 20:1 or greater. In other configurations, one or more of the support connections comprises a length which is equal to or greater than 30 times the width of the support connection. It will be understood that the aspect ratio of one or more of the support connections may thus be 30:1 or greater.

Each post 102 defines an axis P1 which extends radially through the centre of the post 102. It will be understood that each post 102 is located between two adjacent posts 102. Specifically, each post 102 may be next to a first post adjacent to the first lateral extent 103c of the crown 103 and another post adjacent to the second lateral extent 103d of the crown 103. Each post 102 defines an axis P2 which extends radially from a circumferential position between the post 102 and a post 102 adjacent to the first lateral extent 103c of the crown 103. Each post 102 defines an axis P3 which extends radially from a circumferential position equidistant between the post 102 and a post 102 adjacent to the second lateral extent 103d of the crown 103.

FIG. 2 shows an enlarged perspective view of the rotor body 100 of FIG. 1, which comprises a plurality of laminates 200. The rotor body 100 may be defined by a plurality of laminates 200 arranged in a stack. The laminates 200 may be attached to one another by adhesion, pinning, bolting, or any other means of affixation or fastening. It can be seen in both FIGS. 1 and 2 that the flux restriction apertures 107 pass through their associated posts 102 in the direction of the rotational axis L when the stack of laminates 200 is assembled.

Most clearly illustrated in FIG. 2, it can be appreciated that the volume of the crown 103 of each post 102 extends axially through the rotational axis L. Specifically, the proximal end 103a, the distal end 103b, the first side wall 103c, and the second side wall 103d each extend through the stack of laminates substantially continuously. Specifically, these features of contiguous laminates may be arranged co-axially with one another. The support connections 106 may also be present along the axial direction of the structure; however, while the volume of the crown is continuous in the axial direction through the rotational axis L, the volume of the respective support connections 106 comprises voids, or discontinuities, through the same direction. This is explained with reference to the structure of the individual laminate below.

FIG. 3 shows a single laminate 200 for use in the assembly of the rotor body 100 according to FIGS. 1 and 2. The laminate comprises a circumferential support member 201 and a plurality of post members 202 connected to the circumferential support member 201. It will be understood that assembling a plurality of the laminates 200 in an axially extending stack increases the volume of the circumferential support section 201, post members 202 and thereby increases the stiffness of the resulting rotor body. A stack of circumferential support members 201 forms the circumferential support section 101, comprising a back iron, illustrated in FIG. 1. Similarly, stacks of post members 202 form the posts 102 illustrated in FIG. 1.

The plurality of post members 202 extend radially outwards from the circumferential support member 201. Each of the plurality of post members 202 comprises a magnetically conductive crown member 203. The post crown member 203 comprises a first, proximal end 203a which may be connected to the back iron, and a second, distal end 203b. Each post crown member 203 further comprises a first side wall 203c defining a first lateral extent of the post crown member 203 and a second side wall 203d defining a second lateral extent of the post crown member 203. Stacks of crown members 203 form the crowns 103 illustrated in FIG. 1.

The laminate 200 may comprise an alignment feature 209 as shown. The alignment feature comprises a recess 209 on the circumferential support member 201 of the laminate, however it may otherwise comprise a protrusion. The alignment feature 209 provides a reference point during assembly, discussed further below with reference to a method of forming the laminate structure.

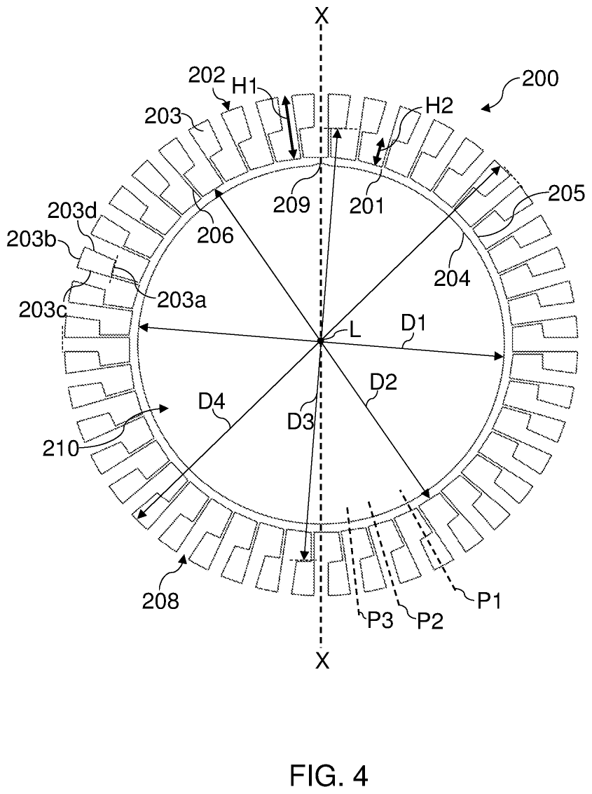

In the illustration of FIG. 4, each post member 202 of the laminate 200 comprises a single support connection 206. As illustrated, each post member 202 may be geometrically identical and each post member 202 may comprise a support connection 206 which extends to the same side wall 203c of each conductive crown member 203.

Thus, in the embodiment illustrated in FIG. 4, the cross-sectional profile of each individual post member 202 of the laminate 200 defines an asymmetric cross-sectional profile through the associated axis P1. Further, each post member 202 defines an asymmetric cross-sectional profile with the adjacent post member 202 through the axis P2, and additionally with the adjacent post through the axis P3. The cross-sectional profile of the laminate 200 therefore defines an asymmetric cross-sectional profile through the line X-X.

Referring back to the voids defined in the volume of the respective associated support connections 106 through the axial direction of the rotational axis L first described with reference to FIG. 2; each individual laminate 200 thus provides a single support connection 206 to each overall post 102. In this way, the support connections 106 of the post 102 may be provided at the first side wall 103c in alternating layers and at the second side wall 103d in alternating layers therebetween.

Thus, the laminates 200 may be arranged to comprise a first plurality of laminates 200 comprising a first plurality of support connections 206 and a second plurality of laminates 200 comprising a second plurality of support connections 206. With the laminate 200 of FIG. 3, a second plurality of laminates 200 may be provided by rotating the laminate 200 through 180 degrees about the line X-X. This provides a plurality of laminates 200 comprising a cross-sectional profile which is substantially the mirror image of the cross-section profile depicted in FIG. 3. When arranged together alternately in a stack, the first and second plurality of laminates 200 may therefore respectively provide support connections 206 at both the first side wall 103c and the second side wall 103d of each post 102.

Overall, the cross-sectional profile of the associated rotor body 100 therefore may define a symmetric cross-sectional profile through the line X-X. Specifically, the rotor body 100 cross sectional profile may comprise a line of mirror symmetry through the line X-X.

In such assemblies, each assembled post 102 may still comprise sufficient stiffness while reducing losses due to magnetic flux leakage. By comprising as few as half the support connections 106, 206, the material of each laminate 200 and thus the volume of the resulting rotor body 100 may be significantly reduced. The mass of the rotor body 100 is likewise reduced.

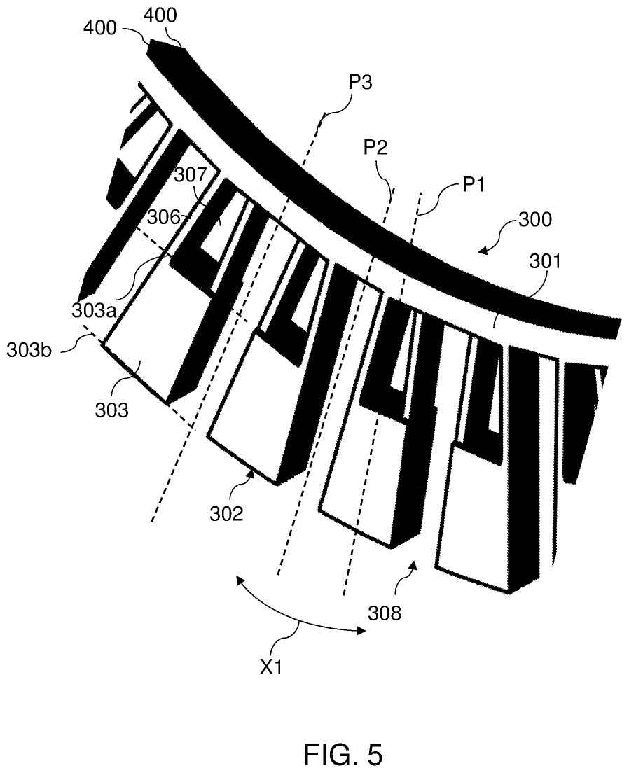

FIG. 5 shows an enlarged perspective view of a first alternative rotor body 300, which comprises a plurality of laminates 400.

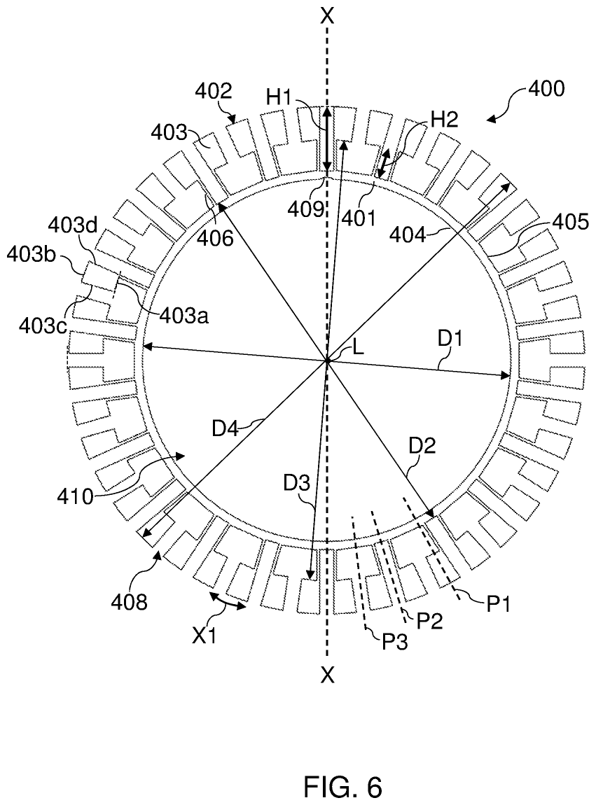

FIG. 6 shows a single laminate 400 for use in the assembly of the first alternative rotor body 300 according to FIG. 5. Similarly to the earlier described laminate 200, the laminate 400 comprises a circumferential support member 401 and a plurality of post members 402 connected to the circumferential support member 401.

Each of the plurality of post members 402 comprises a magnetically conductive crown member 403. The post crown member 403 comprises a first, proximal end 403a and a second, distal end 203b. Each post crown member 203 further comprises a first side wall 403c and a second side wall 403d.

In the illustration of FIG. 6, each post member 402 of the laminate 400 comprises a single support connection 406. However, while each post crown member 403 may geometrically identical, each post member 402 may comprise a support connection 406 which may extend to either side wall 403c, 403d of the associated crown member 403. A post member comprising a support connection extending to the side wall 403c may be adjacent to post members comprising support connections extending to the side wall 403d and vice-versa. In this example, the support connections extend substantially orthogonally to an outer diameter 405 of the circumferential support section 401.

Thus, as with the laminate 200, the cross-sectional profile of each individual post member 402 of the laminate 400 defines an asymmetric cross-sectional profile through the associated axis P1. However, the cross-sectional profile of each post member 402 defines a line of symmetry cross-sectional profile with the adjacent post member 402 through the axis P2, and additionally with the adjacent post through the axis P3. The cross-sectional profile of the laminate 400 may therefore define a symmetric cross-sectional profile through the line X-X.

In this example, each individual laminate 400 thus provides a single support connection 406 to each post 302. In this way, the support connections 306 of any one post 302 may be provided at either side wall 103c, 103d in alternating layers and at the opposite side wall 103c, 103d in alternating layers therebetween.

However, differently to the laminate 200, the laminate 400 may be rotated about the rotational axis L in order to achieve this structure rather than about the line X-X. Specifically, the laminate 400 may be rotated about the rotational axis L through an angular distance X1 or any multiple integer thereof. The angular distance X1 corresponds to the angular distance between a first side wall 403c of a crown member 403 to a first side wall 403c of an adjacent crown member 403. It will be appreciated that this distance may otherwise be the angular distance between a second side wall 403c of a crown member 403 to a second side wall 403c of an adjacent crown member 403.

Overall, the cross-sectional profile of the associated rotor body 300 therefore may also define a symmetric cross-sectional profile through the line X-X. Specifically, the cross-sectional profile of the rotor body 300 may comprise a line of mirror symmetry through the line X-X bisecting the laminate through its axis L.

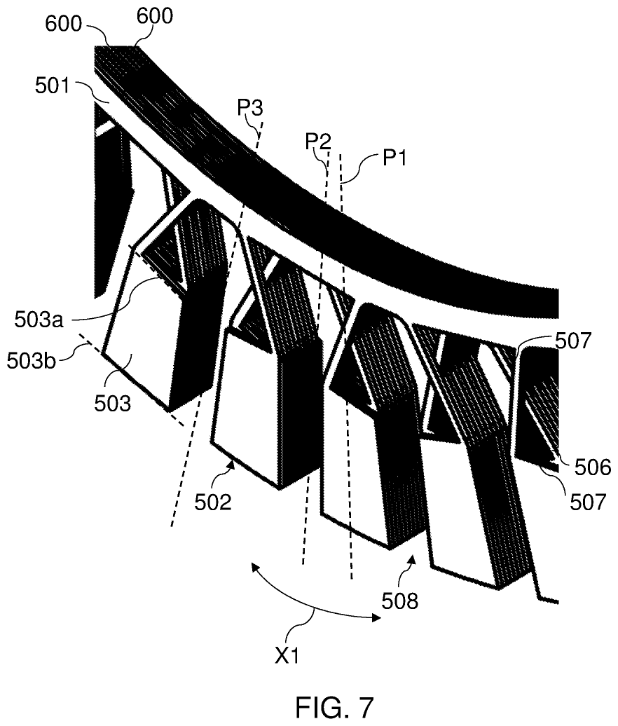

FIG. 7 shows an enlarged perspective view of a second alternative rotor body 500 according to the first aspect of the invention, which comprises a plurality of laminates 600 according to the second aspect of the invention.

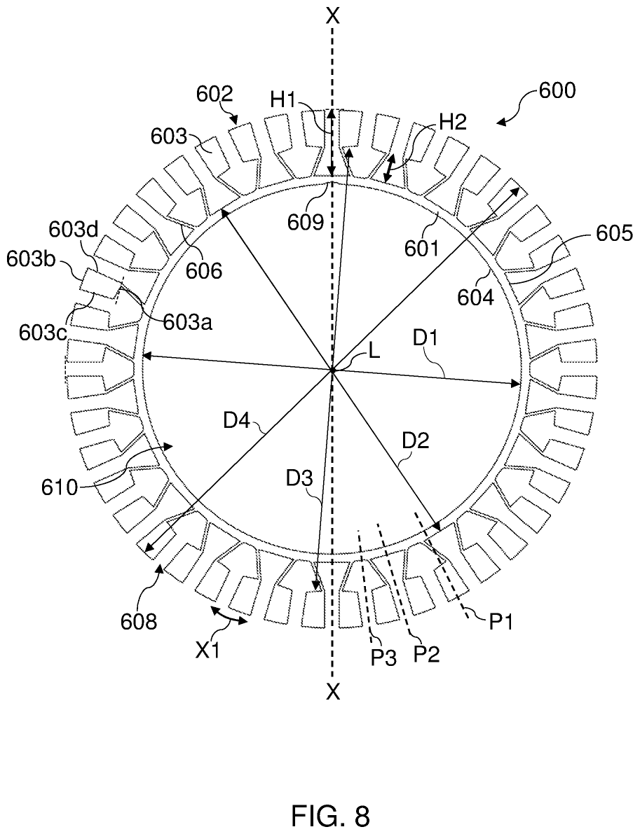

FIG. 8 shows a single laminate 600 according to the second aspect of the present invention for use in the assembly of the second alternative rotor body 500 according to FIG. 7. Analogously to the earlier described laminates 200, 400; the laminate 600 comprises a circumferential support member 601 and a plurality of post members 602 connected to the circumferential support member 601.

Each of the plurality of post members 602 comprises a magnetically conductive crown member 603. The post crown member 603 comprises a first, proximal end 603a and a second, distal end 603b. Each post crown member 603 further comprises a first side wall 603c and a second side wall 603d.

In the illustration of FIG. 8, each post member 602 of the laminate 600 comprises a single support connection 606. Similarly to the laminate 400, while each post crown member 603 may be geometrically identical, each post member 602 comprises a support connection 606 which may extend to either side wall 603c, 603d of the associated crown member 603. A post member comprising a support connection extending to the side wall 603c may be adjacent to post members comprising support connections extending to the side wall 603d and vice-versa. In this example, differently to the laminates 200, 400; the support connections extend substantially obliquely to an outer diameter 605 of the circumferential support section 601.

Thus, as with the laminates 200, 400; the cross-sectional profile of each individual post member 602 of the laminate 600 defines an asymmetric cross-sectional profile through the associated axis P1. However, the cross-sectional profile of each post member 602 defines a symmetrical cross-sectional profile with the adjacent post member 602 through the axis P2, and may additionally do so with the adjacent post through the axis P3. The cross-sectional profile of the laminate 600 may therefore define a symmetric cross-sectional profile through the line X-X bisecting the laminate through its axis L.

In this example, each individual laminate 600 thus provides a single support connection 606 to each overall post 502. In this way, the support connections 506 of any one post 502 may be provided at either side wall 503c, 503d in alternating layers and at the opposite side wall 503c, 503d in alternating layers therebetween.

The support connections 506 of a single post 502 extending obliquely from the circumferential support member 501 may therefore extend across one another. In this way, the support connections 506 may be arranged in a cross braced configuration. This configuration, while decreasing the volume of the arrangement, the load can be distributed throughout the stack of support connections 506 through an intersection of the support connections 506. The resulting triangulation of the load can in turn increase the rigidity of the posts 502.

The cross braced configuration defines two flux restriction apertures 507. A first flux restriction aperture 507 may be bounded by the support connections 506 and an outer circumference 505 of the back iron 501. The second flux restriction aperture 507 may be bounded by the support connections 506 and a proximal end 503b of the post crown 503.

Similarly to the laminate 400, the laminate 600 may be rotated about the rotational axis L through an angular distance X1, i.e. by one tooth spacing, or any integer multiple thereof, to achieve the structure of FIG. 7. It will be understood that, like the laminate 200 of FIG. 4, the laminate 600 may otherwise comprise support connections that are geometrically identical. With this configuration, the laminate 600 may therefore otherwise be configured such that it is instead rotated 180 degrees about the line X-X.

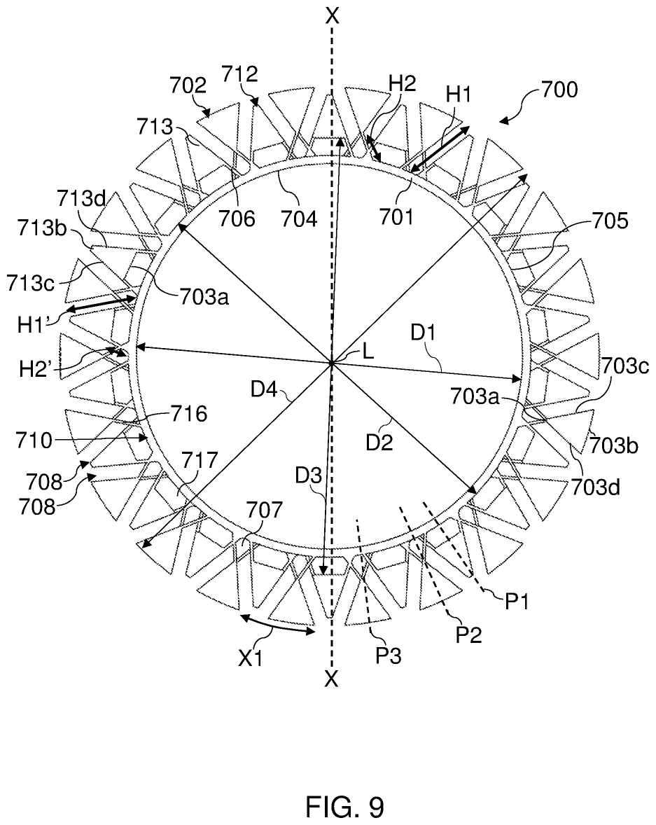

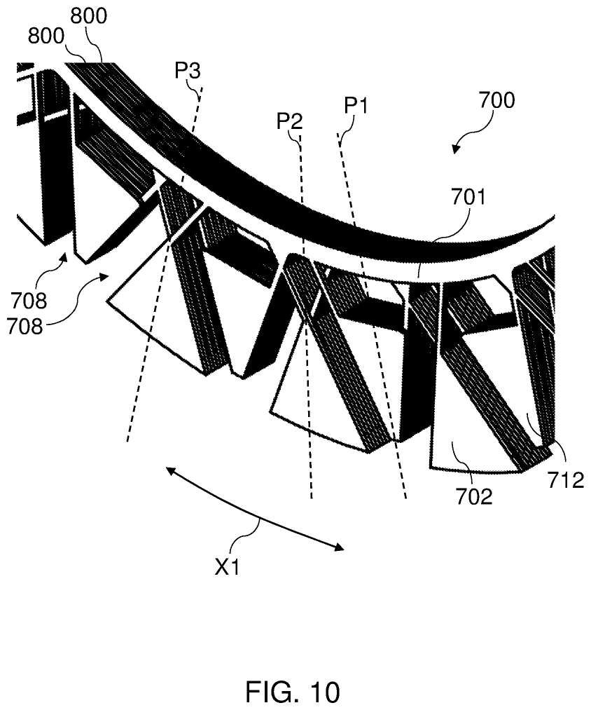

FIGS. 9 and 10 illustrate an alternative rotor body 700. The rotor body 700 comprises a plurality of posts 702, 712 connected to a back iron 701. In the example of FIG. 9, the plurality of posts 702, 712 comprise a plurality of primary posts 702 and a plurality of peripheral posts 712. The primary posts 702 each comprise a post crown 703. The peripheral posts 712 each comprise a peripheral crown 713.

Each post crown 703 comprises a first, proximal end 703a which may be configured to be connected to the back iron 701, and a second, distal end 703b. Each post crown 703 further comprises a first side wall 703c defining a first lateral extent of the post crown 703 and a second side wall 703d defining a second lateral extent of the post crown 703. Likewise, each peripheral crown 713 comprises a first, proximal end 713a which may be configured to be connected to the back iron 711 and a second, distal end 713b. Each post crown 713 may further comprise a first side wall 713c defining a first lateral extent of the post crown 703, and a second side wall 713d defining a second lateral extent of the post crown 703.

Generally, the primary posts 702 may be arranged alternately with the peripheral posts 712 around the outer circumference 705 of the back iron 701. For example, at least one primary post 702 may be arranged such that a peripheral post 712 is arranged adjacent to the associated first side wall 703c and another peripheral post is arranged adjacent to the associated second side wall 703d. In the configuration illustrated, each primary post 702 is adjacent to two peripheral posts 712 and each peripheral post 712 is adjacent to two primary posts 702. It will be understood that any arrangement comprising both primary posts 702 and peripheral posts 712 may be used.

The rotor body 700 further comprises a plurality of magnet-retaining slots 708 which may be bounded between adjacent posts 702, 712. Specifically, in the example of FIGS. 9 and 10, each slot 708 may be bounded by: a first side wall 703c of a primary post 702 and a second side wall 713d of a peripheral post 712; or a first side wall 713c of a peripheral post 712 and a second side wall 703d of a primary post 702. Thus, each primary post 702 may comprise at least two magnet-retaining slots 708 defined between the adjacent peripheral posts 712.

Each primary post 702 may comprise an axis P1 which extends radially through the centre of the primary post 702. Relative to the primary post 702, the peripheral post 712 arranged adjacent to the first side wall 703c of a primary post 702 may comprise an axis P2 which extends radially through the centre of the peripheral post 712. Relative to the primary post 702, the peripheral post 712 arranged adjacent to the second side wall 703d of the primary post 702 may comprise an axis P3 which extends radially through the centre of the peripheral post 712.

Each post comprises a post height H1 which is measured from a base of the post located at the outer circumference 705 of the back iron 701 to a distal end 703b of the conducting crown 703. With this configuration, the post height H1 and the flux restricting region height H2 are measured in a direction parallel to the north-south plane of the at least one magnet provided in the slot 708, and thus, in the example of FIGS. 9 to 12, extends in an oblique direction relative to the outer circumference 705 of the back iron 701. The post height H1 and the flux restricting region height H2 extend parallel to the bounds of the slots 708, or otherwise can be considered to extend parallel to a wall 703c or 703d of a slot.

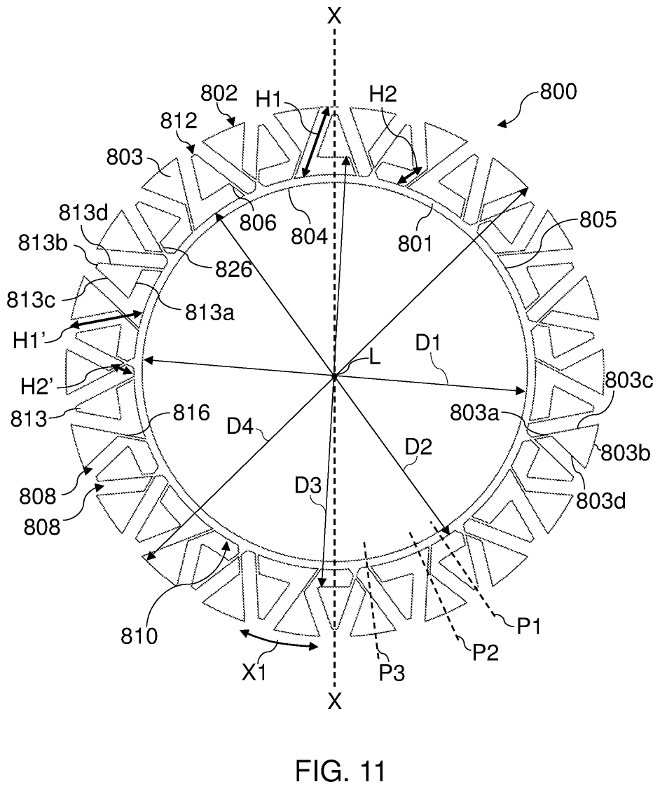

FIG. 11 shows an alternative single laminate 800 according to the second aspect of the present invention for use in the assembly of the alternative rotor body 700 according to FIGS. 9 and 10.

The laminate 800 comprises a circumferential support member 801 and a plurality of post members 802, 812 connected to the circumferential support member 801. The plurality of post members 802, 812 comprise a plurality of primary post members 802 and a plurality of peripheral post members 812.

Each of the plurality of primary post members 802 comprises a magnetically conductive crown member 803. Each of the plurality of peripheral post members 812 comprises a conductive peripheral crown member 813.

In the illustration of FIG. 11, the post members 802, 812 comprise various support connections. A first plurality of primary post members 802 may each be connected to the circumferential support member 801 by a single support connection 806. Likewise, a first plurality of peripheral post members 812 may each be connected to the circumferential support member 801 by a single support connection 816. In the example of FIG. 11, the single support connection 806, 816 extends from the outer circumference 805 of the circumferential support member 801 to a proximal end 803a, 813a of the conductive crown member 803 or the peripheral crown member 813.

A second plurality of the primary post members 802 and a second plurality of the peripheral post members 812 may be connected to the circumferential support member 801 by common support connections 826. That is, a plurality of support connections 826 may each be configured to connect both at least one conductive crown member 803 and at least one peripheral crown member 813 to the circumferential support member 801 by a single support connection.

Considering the cross-sectional profile of any individual primary post member 802, the primary post member 802 may define an asymmetric cross-sectional profile through the associated axis P1. Likewise, the cross-sectional profile of each adjacent peripheral post member 812 may define an asymmetric cross-sectional profile through the associated axis P2, P3. The cross-sectional profile of the laminate 800 may therefore have an asymmetric cross-sectional profile through the line X-X.

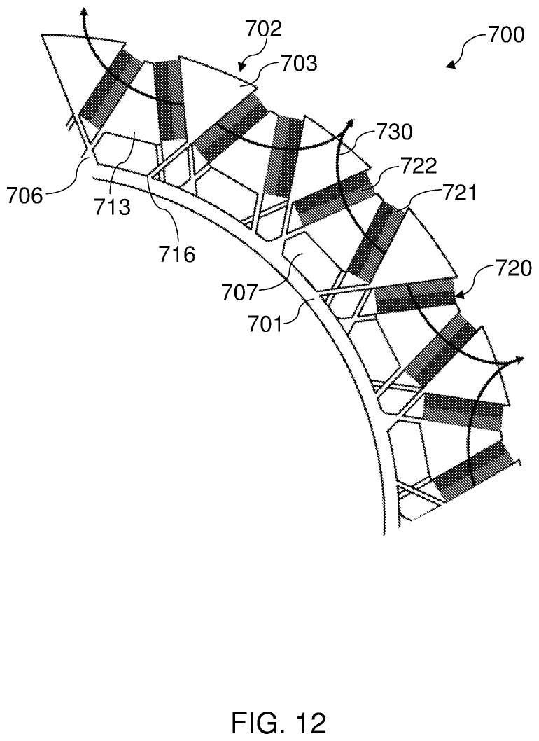

FIG. 12 show magnets 720 which may be disposed within each of the slots 708. The magnets 720 each comprise a north pole 721 and a south pole 722 which define a north-south plane 723 as previously defined with reference to FIG. 3. The magnets 720 may be circumferentially polarised, however, in the configuration of FIG. 12, the pole count is halved relative to the number of magnets 720. Thus, two magnets 720 correspond to a single pole. In this way, an adjacent pair of slots 208 each defined adjacent to the side walls 713c, 713d of a peripheral crown 713 comprise magnets which may be oriented such that their poles are not polarised. Thus, magnetic flux is conducted across said peripheral crown 713. Despite this, the poles adjacent the side walls 703c, 703d of the conducting crown 703 are polarised. In this way, flux 730 is directed radially outward from the conducting crown 703 and towards the air gap and stator (not shown) of the associated electric machine.

Each primary post 702 may comprise a flux restricting region comprising the support connections 706 and an associated flux restriction aperture 707. Each peripheral post 712 may comprise a flux restricting region comprising the support connections 716 and an associated flux restriction aperture 717. The flux restricting region height H2 of the primary posts 702 may extend over at least one fifth of the post height H1. The flux restricting region height H2 of the primary posts 702 may extend over at least one quarter of the post height H1.

It will be understood that the post height and the flux restricting region height of the primary posts 702 and the secondary posts 712 may differ. For example, the primary posts 702 may have a post height H1 and a flux restricting region height H2, while the secondary posts 712 may have a post height H1′ and a flux restricting region height H2′ instead. The flux restricting region height H2′ of the secondary posts 712 may extend over at least one fifth of the post height H1′. The flux restricting region height H2′ of the secondary posts 712 may extend over at least one quarter of the post height H1′.

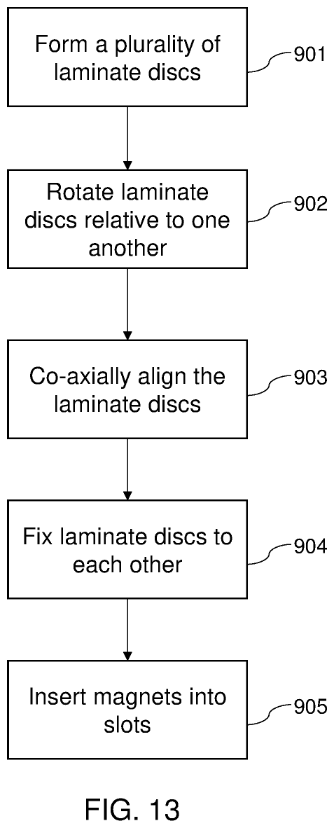

A method, according to a third aspect of the present invention, for providing a stator assembly or a rotor body for an electric machine may generally comprise the steps as set out in FIG. 13.

In step 901, laminate layers 200, 400, 600, 800 may be formed, for example, by machining, laser cutting, punching, fine blanking or etching. The laminates 200, 400, 600, 800 may initially be neither circular nor annular, but may instead start as a sheet of arbitrary shape and may be stamped or machined at during the process to become disks or annular disks. For example, it may be cost-effective to stamp the laminates 200, 400, 600, 800 from sheets of metal. Generally, the geometry of both the stator and rotor slots may be stamped out in a single step, and the rotor laminate is stamped out in a subsequent step.

The step 902 comprises rotating the laminate discs relative to one another. By performing this step, it is possible to provide the plurality of support connections in different laminates of the laminated structure to one another. Specifically, the plurality of support connections of each post may be arranged to connect each to the circumferential support section at different circumferential positions on the post and/or the circumferential support section.

According to step 902, the laminates 200 may be rotated 180 degrees about the line X-X relative to one another. Otherwise, the laminates 400, 600, 800 may be rotated through the angular distance X1 about the rotational axis L. Alternatively, the laminates 400, 600, 800 may be rotated through any integer multiple of X1 about the rotational axis L.

As in step 903, it is subsequently preferable to co-axially align the laminates 200, 400, 600, 800. Once co-axially aligned, the conducting crown members 203, 403, 603, 803 may be stacked on top of one another such that the crowns 103, 303, 503, 703 of the posts 102, 302, 502, 702 comprise a superimposed geometry that is continuous through the axial direction L of the rotor body. Similarly, the circumferential support members 201, 401, 601, 801 comprise a superimposed geometry that is continuous through the axial direction L of the rotor body and in this way form the overall circumferential support section 101, 301, 501, 701. The laminates may otherwise be co-axially aligned by alignment features 209, 409, 609, 809 if the laminates are formed to comprise these. Generally, regardless of the reference point, the co-axially aligned stack of laminates results in the expected laminated structure according to the first aspect of the invention.

According to step 904, the laminate discs may then be fixed to one another. As established earlier, this may comprise on or more of adhesion, pinning, bolting, or any other means of affixation or fastening.

Once formed, the inner circumference of the rotor body may optionally then be secured to a hub/shaft. The rotor body may be set into position with respect to the stator of the electric machine once its assembly is complete.

As a step 905, the magnets may be inserted into the slots of the rotor body. The magnets may be arranged such that the north pole of each magnet faces the north pole of an adjacent magnet, and the south pole of each magnet faces the south pole of an adjacent magnet, as in the example of FIG. 3. It will be appreciated that this magnet configuration applies equally to the examples of FIGS. 4 to 8. On the other hand, the magnet configuration may correspond to that of FIG. 12 and thus two adjacent magnets correspond to a single polarisation. In this way, a pair of adjacent magnets may be arranged such that the north pole of a first magnet faces the south pole of a second magnet, however the south pole of the second magnet faces the south pole of a third magnet. This also results in a circumferential polarisation, however the pole count is halved in this configuration.

In one example, when the magnets are inserted into the slots 108 of the rotor body 100, they are already magnetised. The magnets may be magnetised once they are located within the rotor body 100. In this manner, the magnetic field of each of the magnets does not cause damage to the rotor body 100 by interacting with unintended portions of it. In this preferred example, once the demagnetised magnets are located within the rotor body 100, they may be heated to their Curie temperature and then subjected to a magnetic field in order to magnetise them.

In one example, the magnets may be held in position by means of a potting material. The potting material may be a material with a high melting temperature, such that it does not melt in use.

In the method of forming a rotor, the magnets may be located within the slots of the rotor in a demagnetised state. Before the magnets are magnetised, the potting material may be injected into the slots to backfill them. The potting material may then be allowed to cool, holding the magnets in position within the slots. After the potting material has cooled sufficiently, the magnets may be heated to their Curie temperature and subjected to a magnetic field in order to magnetise them. By preparing the rotor in this way, the rotor is provided with further structural integrity before the magnetic fields of the magnets are introduced.

In an alternative example, the magnets can be magnetised as the potting material may be injected into the slots. In this manner, the heat from the potting material can be used to bring the magnets to the Curie temperature.

The method steps described above are arranged in an exemplary order of performance. However, it is to be understood that the method steps may be performed in a multitude of different orders depending on the requirements. For example, the magnets may be inserted into the slots at any stage, once the rotor body has been formed by stacking the disks. Similarly, the discs may be coated with an adhesive before or after they have been coaxially aligned if being adjoined by adhesion.

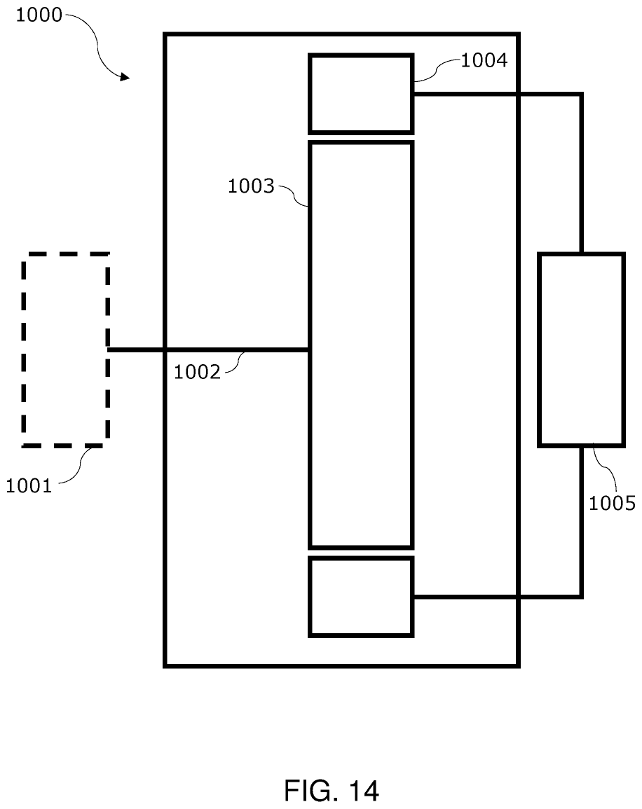

FIG. 14 shows a schematic illustration of an electric machine 1000 which may incorporate the rotor of the present disclosure. The electric machine 1000 comprises a rotor 1003 comprising a plurality of permanent magnets and a stator 1004, which may comprise a plurality of stator windings. The stator 1004 is typically configured as an annular member comprising a bore within which the typically cylindrical rotor 1003 is rotatably mounted. The rotor 1003 ordinarily being arranged concentrically within the bore of the stator 1004, is generally rotatably mounted on a shaft 1002 defining an axis of rotation L therethrough. Either of the rotor 1003 or the stator 1004 may be configured to comprise the laminated structure according to an aspect of the invention. The machine may be configured in an out-runner configuration having a rotor arranged around the stator, or in the illustrated in-runner configuration with the rotor 1003 inside the start 1004.

The electric machine 1000 may be configured to operate as a motor. In this configuration, the stator 1004 is configured to receive electrical power from a power source 1005. The electrical power is provided to the windings of the stator, producing a time-varying magnetic field which causes the rotor 1004 to rotate. The rotor 1004 in turn rotates the shaft 1002 and thus may be used to transfer drive to a prime mover 1001.

Alternatively, the electric machine 1000 may be configured to operate as a generator. In such configurations, the rotor 1003 is generally driven by the prime mover 1001 via the shaft 1002. As the rotor 1003 is rotated about the axis of rotation L within the bore of stator 1004, the magnetic field of the rotor 1003 is also rotated. This causes a rotating magnetic field which interacts with the electrical conductors and thus generates a voltage with the windings of the machine 1000. This voltage may subsequently be supplied to an electrical accessory or component 1005.

Further aspects of the invention can be defined according to the following numbered clauses, features of which may be applied to laminated or non-laminated structures:
1. A structure for forming a rotor or a stator of an electric machine, the structure comprising:
   a circumferential support section;
   a plurality of magnetic posts connected to the circumferential support section;
wherein at least one of the plurality of magnetic posts comprises:
   a plurality of support connections connecting the at least one magnetic post to the circumferential support section;
   wherein at least two of the plurality of support connections bound at least one flux restriction aperture defined in the at least one magnetic post.
2. The structure of clause 1, wherein:
   at least one of the plurality of magnetic posts comprises a magnetically conducting region comprised primarily of magnetically conductive material; and
   a flux restricting region comprising the support connections and the at least one flux restriction aperture;
   at least one of the plurality of magnetic posts having a post height (H1), measured from the base of the at least one post, adjacent the circumferential support section, to a tip of the at least one post, distal from the circumferential support section;
   wherein the flux restricting region has a flux restricting region height (H2) which extends over at least one fifth of the post height.
3. The structure of clause 2, wherein the flux restricting region height (H2) extends over at least one quarter of the post height (H1).
4. The structure of clause 2 or clause 3, wherein the flux restricting region height (H2) extends over at least one third of the post height (H1).
5. The structure of any preceding clause, wherein:
   the distance between opposed inner circumferences of the circumferential support section defines a first diameter (D1);
   the distance between opposed outer circumferences of the circumferential support section defines a second diameter (D2);
   the distance between the distal ends of any two opposed support connections defines a third diameter (D3);
   the distance between the distal ends of any two opposed magnetic posts defines a fourth diameter (D4).
6. The structure of clause 5, wherein the third diameter (D3) is equal to or greater than 1.1 times the second diameter (D2).
7. The structure of clause 5 or clause 6, wherein the third diameter (D3) is equal to or greater than 1.2 times the second diameter (D2).
8. The structure of any of clause 5 to clause 7, wherein the third diameter (D3) is equal to or greater than 1.3 times the second diameter (D2).
9. The structure of any preceding clause, wherein a length to width aspect ratio of the one or more support connections is 3:1 or more.
10. The structure of clause 9, wherein length to width aspect ratio of the one or more support connections is 5:1 or more; or 9:1 or more; or 20:1 or more; or 30:1 or more.
11. The structure of any preceding clause, wherein:
   at least two adjacent posts of the plurality of magnetic posts each comprise a first side wall defining a first lateral extent of a post crown and a second side wall defining a second lateral extent of a post crown; and
   at least one magnet-retaining slot is defined between a first side wall of one of the at least two adjacent posts and a second side wall of the other of the at least two adjacent posts.
12. The structure of clause 11, wherein each of the plurality of magnetic posts comprises a first side wall defining a first lateral extent of a post crown and a second side wall defining a second lateral extent of a post crown; and
   magnet-retaining slots are defined between each first side wall of the posts and each second side wall of the adjacent post.
13. The structure of clause 11 or clause 12, wherein the post height (H1) and/or the flux restriction region height (H2) are measured in a direction parallel to the first or second side walls of the post crowns.
14. A laminate for forming a laminated rotor or stator of an electrical machine, the laminate comprising:
   a circumferential support member; and
   at least one magnetic post member comprising at least one support connection connecting the at least one magnetic post member to the circumferential support member;
   wherein the laminate is configured such that, when a plurality of such laminates is arranged co-axially, co-axial magnetic post members form at least one magnetic post comprising:
      a plurality of support connections connecting the at least one magnetic post to the circumferential support section;
         wherein at least two of the plurality of support connections bound at least one flux restriction aperture defined in the at least one magnetic post.
15. The laminate of clause 14, wherein the at least one magnetic post member comprises a magnetically conducting region comprised primarily of magnetically conductive material; and
   a flux restricting region comprising the at least one support connection;
   the at least one magnetic post member having a post height (H1), measured from the base of the at least one post, adjacent the circumferential support section, to a tip of the at least one post member, distal from the circumferential support section;
   wherein the flux restricting region has a flux restricting region height (H2) which extends over at least one fifth of the post height.
16. The laminate of clause 15, wherein the flux restricting region height (H2) extends over at least one quarter of the post height (H1).
17. The laminate of clause 14 or clause 15, wherein the flux restricting region height (H2) extends over at least one third of the post height (H1).
18. A method providing a stator or a rotor for an electric machine, comprising:
   providing a plurality of laminates, at least one of the laminates comprising:
      a circumferential support member; and
      a plurality of magnetic post members, comprising a plurality of support connections extending circumferentially from the circumferential support member and connecting the magnetic post members to the circumferential support member;
   the method comprising forming a laminated structure by arranging the plurality of laminates together, the laminated structure comprising:
      a circumferential support section; and
   at least one magnetic post formed from at least two of the magnetic post members;
   wherein the step of forming the laminated structure comprises arranging the plurality of laminates together such that the at least two of the plurality of support connections of at least one post bound at least one flux-restriction aperture defined in the at least one post.
19. The method of clause 18, wherein at least two laminates of the plurality of laminates each comprise:
   at least one magnetic post member; and
   at least one support connection connecting the at least one magnetic post member to the circumferential support member;
   wherein the magnetic post members of each laminate each define an asymmetric cross-sectional profile, the method further comprising the step of arranging the at least two laminates together such that at least one post comprises a symmetrical cross-sectional profile.
20. The method of either of clause 18 or clause 19, further comprising arranging at least two of the plurality of support connections of one of the plurality of magnetic posts in different contiguous laminates of the structure to one another such that the magnetic post is connected to the circumferential support section at different circumferential positions on the post and/or the circumferential support section.
21. The method of clause any of clauses 18 to 20, wherein the plurality of laminates provided further comprises:
   a first plurality of laminates comprising a first plurality of support connections; and
   a second plurality of laminates comprising a second plurality of support connections;
   the method further comprising forming the laminated structure such that the first plurality of support connections are formed at different circumferential positions on the post and/or the circumferential support section to the second plurality of support sections.
22. The method of clause 21, further comprising the step of rotating the second plurality of laminates relative to the first plurality of laminates such that the first plurality of support connections are formed at different circumferential positions on the post and/or the circumferential support section to the second plurality of support sections.
23. The method of clause 22, wherein at least two of the plurality of laminates each comprise an alignment feature indicating the correct orientation of the at least two laminates.
24. The method of any of clause 21 to clause 23, further comprising arranging at least one of the first plurality of laminates contiguously with at least one of the second plurality of laminates within the at least one laminated structure.
25. The method of any of clauses 19 to 24 further comprising arranging the plurality of laminates together such that the plurality of support connections of at least one post bound at least one flux-restriction aperture defined through the at least one post.
26. The method of clause 25, further comprising providing at least two of the plurality of support connections in different laminates of the laminated structure to one another, the at least two of the plurality of support connections connecting at least one of the plurality of magnetic posts to the circumferential support section at different circumferential positions on the post and/or the circumferential support section.
27. An electric machine, comprising:
   a stator;
   a rotor having a rotational axis;
   the rotor being rotatably mounted for rotation relative to the stator about the rotational axis;
   at least one of the stator and the rotor comprising:
   a structure according to any of clauses 1 to 13; or
   a laminate according to any of clauses 14 to 17; or
   a laminated structure formed according to the method of any of clauses 18 to 26.

1. A laminated structure for forming a rotor or a stator of an electric machine, the laminated structure comprising:
a plurality of laminates;
the plurality of laminates being arranged together to provide:
a circumferential support section; and
a plurality of magnetic posts connected to the circumferential support section;
wherein at least one of the magnetic posts comprises a plurality of support connections connecting the magnetic post to the circumferential support section;
at least two of the plurality of support connections being formed in different laminates of the laminated structure to one another and connecting one of the plurality of magnetic posts to the circumferential support section at different circumferential positions on the post and/or the circumferential support section.

2. The laminated structure of claim 1, wherein the at least two of the plurality of support connections are formed in different adjoining laminates of the laminated structure to one another.

3. The laminated structure of claim 1, wherein the plurality of laminates further comprises:
a first plurality of laminates comprising a first plurality of support connections; and
a second plurality of laminates comprising a second plurality of support connections;
wherein the first plurality of support connections are formed at different circumferential positions on the post and/or the circumferential support section to the second plurality of support connections.

4. The laminated structure of claim 3, wherein the second plurality of laminates have a different rotational orientation relative to the first plurality of laminates, which difference causes the first plurality of support connections to be formed at different circumferential positions on the post and/or the circumferential support section to the second plurality of support sections.

5. The laminated structure of claim 3, wherein at least one of the first plurality of laminates is arranged contiguously with at least one of the second plurality of laminates within the laminated structure.

6. The laminated structure of claim 3, wherein the first plurality of laminates and the second plurality of laminates are substantially geometrically identical.

7. The laminated structure of claim 1, wherein at least one flux-restriction aperture passes partially or completely through the at least one post in a direction of the rotational axis.

8. The laminated structure of claim 1, wherein the at least two of the plurality of support connections which are formed in different laminates of the laminated structure to one another, and which connect one of the plurality of magnetic posts to the circumferential support section at different circumferential positions on the post and/or the circumferential support section, overlap one another.

9. The laminated structure of claim 1, comprising a rotational array of the magnetic posts, a plurality of the magnetic posts of the array each comprising a plurality of respective support connections connecting the respective magnetic post to the circumferential support section;
at least one set of the respective support connections being formed in different laminates of the laminated structure to one another and connecting a respective one of the plurality of magnetic posts to the circumferential support section at different circumferential positions on the post and/or the circumferential support section.

10. The laminated structure of claim 3, wherein the first plurality of laminates and the second plurality of laminates are arranged alternately within the at least one laminated structure.

11. A laminate for forming a laminated rotor or stator for an electrical machine, the laminate comprising:
a circumferential support member; and
a plurality of magnetic post members,
at least one of the plurality of magnetic post members:
being circumferentially centred about a respective radius of the laminate and defining an asymmetric cross-sectional profile about the respective radius;
comprising at least one support connection extending from the circumferential support member to the magnetic post member and connecting to the magnetic post member and/or the circumferential support member at a point away from the respective radius about which the respective magnetic post member is centred;
the laminate being configured such that a plurality thereof can be assembled into a laminated structure comprising a circumferential support section and a plurality of magnetic posts connected to the circumferential support section;
such that at least one of the magnetic posts of the laminated structure comprises a plurality of support connections, connecting the magnetic post to the circumferential support section; and
at least two of the plurality of support connections are formed in different laminates of the laminated structure to one another and connect one of the plurality of magnetic posts to the circumferential support section at different circumferential positions on the post member and/or the circumferential support section.

12. The laminate of claim 11, wherein a plurality of the magnetic post members of the laminate are substantially geometrically identical.

13. The laminate of claim 11, wherein the plurality of magnetic post members comprises:
a first plurality of magnetic post members comprising a first plurality of support connections extending from the circumferential support member connecting the magnetic post members to the circumferential support member; and
a second plurality of magnetic post members comprising a second plurality of support connections extending from the circumferential support member connecting the magnetic post members to the circumferential support member.

14. The laminate of claim 13, wherein the cross-sectional profiles of the second plurality of magnetic post members comprise mirror symmetry with the cross-sectional profiles of the first plurality of magnetic post members.

15. The laminate of claim 11, further comprising an alignment feature.

16. The laminate of claim 15, wherein the alignment feature comprises a protrusion or a recess on an inner or outer circumference of the laminate.

17. A method providing a stator or a rotor for an electric machine, comprising:
providing a plurality of laminates, at least one of the laminates comprising:
a circumferential support member; and
a plurality of magnetic post members, comprising a plurality of support connections extending circumferentially from the circumferential support member and connecting the magnetic post members to the circumferential support member;
the method comprising forming a laminated structure by arranging the plurality of laminates together, the laminated structure comprising:
a circumferential support section; and
at least one magnetic post formed from at least two of the magnetic post members;
wherein the step of forming the laminated structure comprises providing at least two of the plurality of support connections in different laminates of the laminated structure to one another, the at least two of the plurality of support connections connecting at least one of the plurality of magnetic posts to the circumferential support section at different circumferential positions on the post and/or the circumferential support section.

18. The method of claim 17, wherein at least two laminates of the plurality of laminates each comprise:
at least one magnetic post member; and
at least one support connection connecting the at least one magnetic post member to the circumferential support member;
wherein at least one magnetic post member of each laminate defines an asymmetric cross-sectional profile;
the method further comprising the step of arranging the at least two laminates together, such that respective magnetic post members which each define asymmetric cross-sectional profiles form at least one post comprising a symmetrical cross-sectional profile.

19. The method of claim 17, further comprising arranging at least two of the plurality of support connections of one of the plurality of magnetic posts in different contiguous laminates of the structure to one another such that the magnetic post is connected to the circumferential support section at different circumferential positions on the post and/or the circumferential support section.

20. The method of claim 18, wherein the plurality of laminates further comprises:
a first plurality of laminates comprising a first plurality of support connections; and
a second plurality of laminates comprising a second plurality of support connections;
the method further comprising forming the laminated structure such that the first plurality of support connections are formed at different circumferential positions on the post and/or the circumferential support section to the second plurality of support sections.

21.-26. (canceled)
